(19) United States
(12) Patent Application Publication
(10) Pub. No.: US 2002/0118352 A1
(43) Pub. Date: Aug. 29, 2002

(54) Fast gate scanning three-dimensional laser radar apparatus

(75) Inventors: Akira Ohzu, Kyoto (JP); Yoichiro Maruyama, Ibaraki (JP); Masaaki Kato, Ibaraki (JP)

Correspondence Address: BANNER & WITCOFF, 1001 G STREET N W, SUITE 1100, WASHINGTON, DC, 20001, US

(73) Assignee: Japan Atomic Energy Research Institute, Chiyoda-ku (JP)

(21) Appl. No.: 10/055,175

(22) Filed: Jan. 25, 2002

(30) Foreign Application Priority Data
Feb. 23, 2001 (JP) 48483/2001

(51) Int. Cl. G01C 3/08

(52) U.S. Cl. 356/5.04

(57) ABSTRACT

A fast gate scanning three-dimensional laser radar apparatus operating on such principles as fluorescence scattering, Raman scattering and differential absorption scattering, which uses a high-sensitivity, two-dimensional imaging CCD camera, an image intensifier or other two-dimensional photodetector suitable for use as a laser echo light signal receiver and detector that is designed to have a gating feature with short time slot, a fast gate scanning feature and a high frame (image capture) repetition rate so that a two- or three-dimensional spatial density distribution of fine particles, environmental pollutants, aerosols and other targets suspended in the atmosphere is acquired instantaneously whereas temporal changes in the direction, speed and flow of the distribution can be remotely monitored.

### BACKGROUND OF THE INVENTION

This invention has basic use in areas where the laser radar apparatus is employed, specifically in the environment analyzing industries to observe or detect harmful pollutants, endocrine disrupters, aerosols and fine particles that are suspended in the atmosphere as emissions from various naturally occurring phenomena, industrial activities and traffic vehicles, or in weather industries to investigate the distributions or states of the atmospheric temperature, flows, water vapor, carbon dioxide, etc., as well as in the industrial and academic circles that measure the gases, volcanic ashes and other emissions from volcanoes and oceans.

In the basic approach of the conventional laser radar system, laser pulsed light is issued in one direction toward target substances in the atmosphere such as aerosols and fine particles and the laser echo light (received signal) returning as the result of interactions such as backward scattering is analyzed to produce information on a one-dimensional spatial distribution of the target substances over a very narrow range in the direction of laser input. In order to obtain information on a two- or three-dimensional spatial distribution of target substances over a wide range, laser pulsed light need be applied to scan a broad range of the atmosphere in which the target substances exist.

This need of scanning laser pulsed light in various directions makes it generally impossible to measure two-dimensional spatial distributions by applying one shot of laser pulses and involves very prolonged measurements. Long detection times are also required to obtain information on a two- or three-dimensional spatial distribution of suspended matter by analyzing laser echo light. Even if a two-dimensional gating image detector such as a CCD (charge-coupled device) is used, one can only acquire a two-dimensional distribution of a specified gate delay time within a specified gate time slot.

In order to acquire three-dimensional distributions, the gate delay time need be shifted by small increments. Since this involves lengthy times of measurement, an instantaneous change in the spatial distribution of atmospheric substances causes a marked deterioration in the spatial and temporal precision of the distribution measured. In particular, it is impossible to determine precise information on a two- or three-dimensional spatial distribution of substances in an atmosphere having high wind speed.

In the conventional laser radar system, the laser echo light collected by a condensing device such as a telescope is detected by a unit comprising a single high-sensitivity light receiving portion, a semiconductor device, a photodiode and a secondary-electron multiplier. As a result, one can only obtain information on the one-dimensional dimensional temporal change of the laser echo light.

To obtain information on the spatial distribution of substances such as aerosols over a wide area of the atmosphere, laser pulsed light need be applied in various directions over a prolonged time. Use of a two-dimensional detector such as a CCD is basically intended to measure a two-dimensional distribution and a prolonged time is necessary to measure a three-dimensional distribution. It is therefore difficult for the conventional methods to achieve instantaneous gathering of information on the two- or three-dimensional spatial distribution of atmospheric suspended matter.

### SUMMARY OF THE INVENTION

In the laser radar system of the invention, a two-dimensional device such as CCD or MCP having fast gate scanning feature and high frame repetition rate is used in the detector of laser echo light. As a result, laser echo light signals can be picked up as two-dimensional image data representing finely divided portions of a space in the atmosphere and this is combined with the fast gate scanning feature to achieve instantaneous capture of a three-dimensional spatial distribution of suspended matter.

The fast gate scanning three-dimensional laser radar of the invention comprises (a) a pulse oscillating, pulsed laser light generator, (b) a laser pulsed light emitter capable of scanning a wide range of the atmosphere to be analyzed, (c) means for collecting backscattered laser echo light returning on account of the interaction between the emitted laser pulsed light and the suspended matter in the atmosphere such as aerosols or fine particles, (d) a light receiver/detector having a two-dimensional device capable of capturing the backscattered light as a two-dimensional phenomenon and (e) a control and data analyzer which controls individual devices (a)-(d) and analyzes the obtained data, further characterized in that the laser echo light is captured with the two-dimensional device in said light receiver/detector and the fast gate scanning feature of said two-dimensional device is utilized to measure a two- or three-dimensional spatial distribution of the suspended matter in the atmosphere.

### BRIEF DESCRIPTION OF THE DRAWINGS

FIG. 1 is a schematic representation of a three-dimensional laser radar system incorporating the concept of the invention;

FIG. 2A shows laser echo light (backscattered light) collected on a two-dimensional light detecting plane (CCD);

FIG. 2B shows the gate time of a pixel on the CCD plane (top) and the incident laser echo scatter signal (bottom);

FIG. 3A shows the short gate time of a pixel (top) and the incident laser echo scatter signal (bottom);

FIG. 3B shows the short gate time of a pixel (top) and the incident laser echo scatter signal obtained by scanning the gate delay time (bottom);

FIG. 4 shows laser echo scatter signals obtained by shortening the gate time of linearly arranged pixels and scanning the gate delay time;

FIG. 5A shows a cross-sectional distribution of aerosols in the atmosphere as obtained by application of laser light, with the gate delay time held constant;

FIG. 5B shows a three-dimensional image of the aerosols as obtained by shortening the gate time of pixels on the CCD plane and scanning the gate delay time; and

FIG. 6 shows the data obtained by observation with a fast gate scanning CCD camera using the concept of the invention.

### DETAILED DESCRIPTION OF THE INVENTION

In the first place, the two-dimensional device such as CCD or MCP which are used in the laser radar system of the invention and which has fast gate scanning feature and high frame repetition rate picks up laser echo light signals as two-dimensional image data representing finely divided portions of a space in the atmosphere and this enables that a two-dimensional spatial distribution of suspended matter to be captured instantaneously.

Using the fast gating feature, it is also possible to capture instantaneously the information on a spatial cross-sectional distribution of substances in the atmosphere at any distance away from the laser radar apparatus (i.e., information on a two-dimensional spatial distribution at a specified distance). If the delay time of the gate from the point in time when the laser was emitted is shifted continuously for successive shots of laser pulsed light using the gating feature, one can also obtain information on continuous spatial cross-sectional distributions; by connecting these spatial distributions with the fast frame feature (high image capture and processing frequencies), a three-dimensional spatial distribution can be obtained instantaneously.

The apparatus needed in the invention comprises (a) a pulse oscillating, pulsed laser light generator, (b) emerging laser beam optics, (c) optics for selecting laser echo scattered light and collecting it on the plane of a two-dimensional device (the optics including those for collecting laser echoes and interference filters), (d) a two-dimensional light receiver/detector, and (e) a control/analyzer unit that controls the overall system and which analyzes data to provide a display on the screen (i.e., system control and data processor/analyzer).

The fine particles or aerosols that are suspended in the atmosphere as emissions from industrial plants or nature are distributed at certain altitudes over an area. The area over which the fine particles or aerosols are distributed is irradiated with widely spread beams of pulsed laser light that are issued from the laser generator via the emerging laser beam optics under the control of the control/analyzer unit.

The applied laser light interacts with the suspended fine particles in the atmosphere to be backscattered as laser echo light, which passes through the scattered light collecting optics (laser echo collecting optics) to be collected on the two-dimensional light receiver/detector; by controlling the two-dimensional light receiver/detector with the control/analyzer unit, a two- or three-dimensional spatial distribution of the fine particles is obtained; these spatial distributions are analyzed to obtain data on the speed and direction of the fine particulate masses.

The two-dimensional device to be used in the invention is a CCD or an image intensifier using a microchannel plate. In the invention, these devices are furnished with a fast gate scanning feature that has a sufficiently short gate width that spatial information for the atmosphere is finely divided to enable instantaneous observation of a two- or three-dimensional spatial distribution of suspended matter. It is in this respect that the concept of the invention is distinguished from the conventional methods which use two-dimensional devices.

In the present invention, the temporal changes in the information on a two- or three-dimensional distribution that is repeatedly obtained with the two-dimensional photodetector, high-speed CCD camera and the like are analyzed by the correlation method or the like to measure the speeds and directions of distributions of fine particles or aerosols suspended in the atmosphere. By using this technique to operate the apparatus of the invention, two similar spatial distributions of fine particles or aerosols are displayed on the computer screen at two times spaced by several seconds. From the spatial shift between these two sets of data and the time difference between the two measurements, the speed and direction of the flow of the target fine particles in the atmosphere can be determined by processing the image data on the computer.

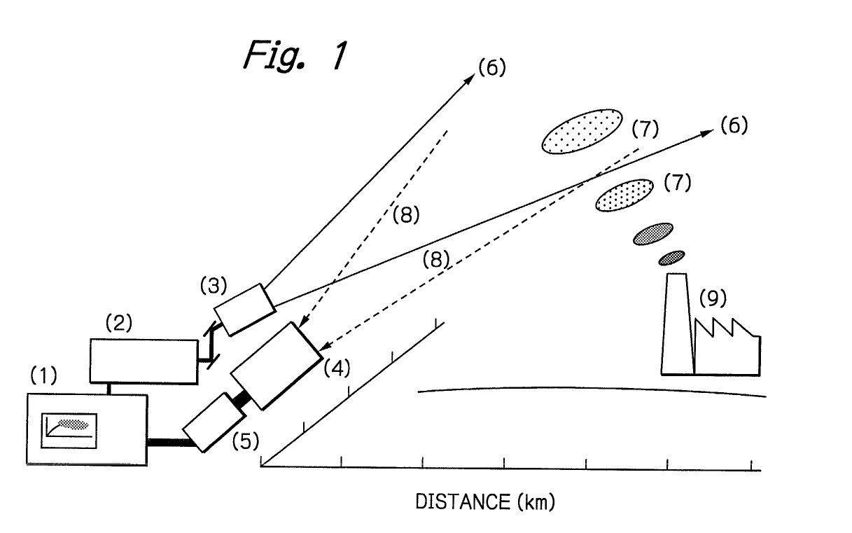

FIG. 1 is a schematic representation of a three-dimensional laser radar system incorporating the concept of the invention. The system comprises a pulse oscillating laser (pulsed laser generator) 1, optics 3 for launching a wide spread of laser beams toward the atmosphere, laser echo light condensing optics 4 that are equipped with light selecting devices such as filters for selecting laser echo light coming from a distant point and which condenses the light over a wide area of a two-dimensional light receiver/detector 5 having fast gate scanning feature, and a system control unit combined with an analyzing unit that analyzes the detector-obtained data and displays the result of the analysis on the screen (system control and data processor/analyzer 1).

First assume that aerosols or groups of fine particles 7 that have been emitted from an industrial plant or nature are distributed in the atmosphere at a certain height over an area. A comparatively wide beam of pulsed laser light 6 is directed toward the aerosols 7 to cover the area over which they are distributed. In the case of a narrow beam of laser light, a spatial scan is made to cover the area over which the aerosols are distributed.

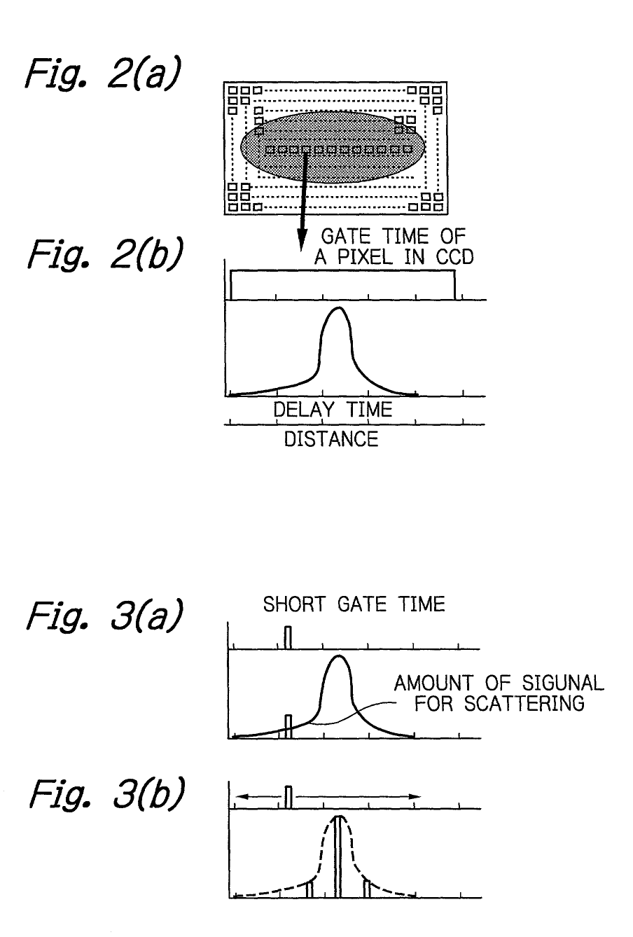

The applied laser light is reflected by backscattering from aerosols 7 distributed in the atmosphere and the resulting backscattered light (laser echo light) 8 returns toward the laser as shown in FIG. 1. This light is condensed by the laser echo light condenser 4 such as a telescope and imaged on the light detecting plane of the two-dimensional light receiver/detector 5 such as a combination of high-sensitivity MCP and CCD or a high-sensitivity CCD (see FIG. 2A).

The method of obtaining a two-dimensional and a three-dimensional spatial distribution of aerosols in the atmosphere is described below with reference to the case of using a high-sensitivity CCD. A pixel on the plane of a high-sensitivity CCD for collecting the backscattered laser echo light (see FIG. 2A) receives backscattered light with a luminance Pr(R,λr) from distance R which generally complies with the following lidar equation (1) and takes on a signal waveform as shown in FIG. 2B:

Pr(R,λr)=P₀K·(cτ/2)Arβ(R)Y(R)F(R)·exp(−∫₀^{R}α(λ₀,r)dr−∫₀^{R}α(λᵣr)dr)/R² (1)

where Pr(R,λr)=backscattered light (at wavelength of λr) from distance R, P₀=laser power (laser issued at wavelength of λₒ), K=the efficiency of signal receiving optics, c=the speed of light, τ=the width of laser pulse, Ar=the light receiving area of telescope, β(R)=backward differential scattering cross section, Y(R)=the proportion of laser light included in the visual field of the telescope, ∫₀^{R}α(λ₀,r)dr=the optical thickness, and a α=the product of the concentration of the target substance n and the absorption cross section.

If the gate time slot of pixels in the CCD is adjusted to be longer than the time duration of the laser echo light returning from each point in the spatial distribution of aerosols, a value obtained by accumulating or integrating signals of the waveform shown in FIG. 2B within the gate time is detected on one pixel. The signal for backward scattering shown in FIG. 2B is a signal of the same type as detected by the conventional method; the delay time of this signal represents the distance from the laser launcher (2 and 3 in FIG. 1) to each point in the distribution of aerosols and the signal intensity represents the concentration of the aerosol at each point. The two-dimensional array of the quantities of pixel signals is displayed on a two-dimensional screen to produce a two-dimensional spatial distribution of aerosols which is the result of two-dimensional compression of aerosols that are distributed three-dimensionally in the atmosphere as seen from the point where laser was issued. The total quantity of the pixel signals gives an estimate of the amount of aerosols existing in the direction of laser application.

If the CCD is furnished with a fast gate scanning feature and a gate delaying feature, the gate time slot of the pixels in the CCD can be shorted as shown in FIG. 3A and a suitable delay time can be provided. As a result, the signal for scattered laser echo light which varies with time can be resolved in time up to a minimum gate time slot. The minimum gate time slot represents a minimum distance to which a spatial distribution can be resolved. If the minimum gate time slot is 1 ns (10⁻⁹ second), the minimum resolving distance is 30 cm. The amount of signals from the CCD that are detected within this gate time represents the integral of signals for scattering picked up within this short gate time slot. The shorter the gate time slot, the closer the amount of a particular signal is to the true value of the signal for scattering from the point of interest. If scanning is performed with the gate delay time being shifted in either a continuous or a discontinuous way while maintaining the short gate slot, signals for scattering are obtained as shown in FIG. 3B and they are not the same as the integral obtained in the above-mentioned case of long gate time but are similar to the signals shown in FIG. 2B which are detected by the conventional method.

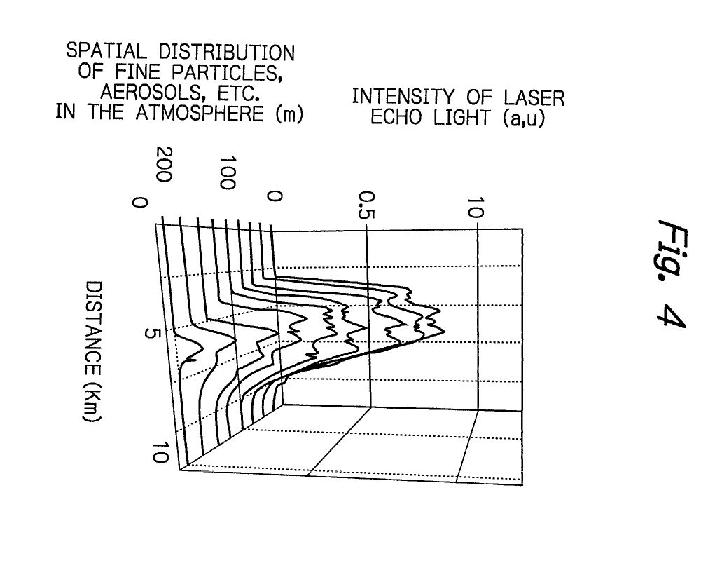

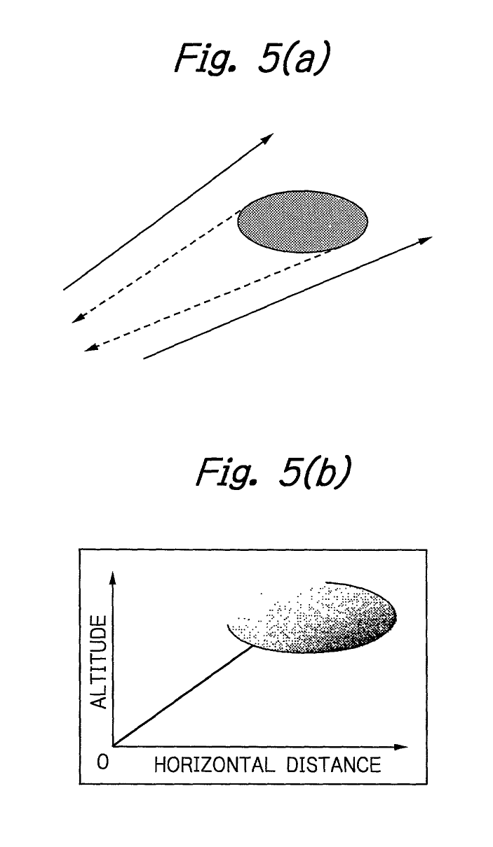

FIG. 4 shows the signals for scattering that are obtained by scanning the gate delay times for a linear array of pixels. In this way, a spatial distribution of signals for scattering can be obtained instantaneously. If the gate time slot of each of the pixels in the CCD is shorted and the delay time maintained constant, one can measure a spatial cross-sectional distribution of aerosols existing a certain distance away from the laser launcher as shown in FIG. 5A.

If the signals for scattering shown in FIG. 4 are measured for the entire part of the CCD, one can measure a three-dimensional distribution of fine particles or aerosols in the atmosphere and display it on the CRT screen as shown in FIG. 5B, thereby permitting instantaneous measurement of the spatial distribution of the concentration of aerosols in the atmosphere. The precision of the three-dimensional distributions that can be obtained by the invention depends on the gate time slot, scan speed for delayed gates, and the speed at which the CCD captures images (frames). Therefore, if the gate time slot is short and the scan speed and the capture speed are high, the direction and speed of an aerosol mass suspended in the atmosphere and the speed of its diffusion can be detected with high precision.

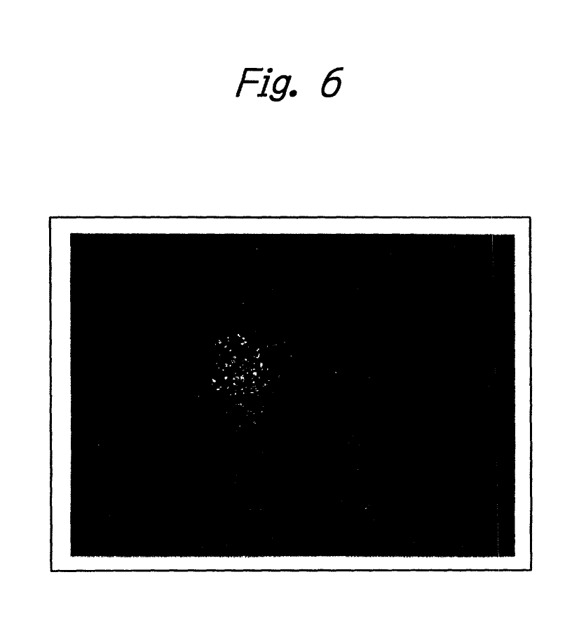

FIG. 6 shows image data obtained by the above-described measuring system; specifically, YAG laser light with a spot size of about 1 cm (wavelength, 532 nm; pulse width, 3 nm; pulse energy, 30 mJ) was launched to the atmosphere at a half angle of about 1° and the laser echo light scattered from fine particles or aerosols about 100 m distant in the atmosphere was captured with a CCD camera having a gate slot of about 3 nm. The white spots in FIG. 6 represent the scattered light from fine particles suspended in a cylindrical space about 3 m in diameter and about 0.9 m long that was 100 m away from the position where laser was issued.

By counting these white spots and processing the associated data, one can determine the quantity and size of the fine particles present in nearby areas. By monitoring the determined values, one can observe the temporal variations in those values. If the gate delay time is scanned for successive emissions of laser light pulses, the spatial distribution of the fine particles can be measured over a wide area within a short time.

By using the apparatus of the invention, a two- or three-dimensional spatial distribution of fine particles or aerosols suspended in the atmosphere can be measured instantaneously over a much wider area with a much higher precision than has has been possible in the conventional methods. This provides quicker access to information about volcanic eruptions, photochemical smog, air pollution by environmental contaminants and environmental pollution from automotive exhaust gases. These pieces of information are used to set up effective measures against environmental pollution, thus contributing to environmental protection and preservation.

If harmful substances are inadvertently released into the atmosphere from plant facilities, the apparatus of the invention can effectively be used in evacuating the residents and passersby from the surrounding areas and guiding them to safe areas. In addition, precise temporal information about second-to-second variations in the spatial distribution, speed and direction of harmful suspended matter in the atmosphere can be presented by image or other media.

What is claimed is:

1. A fast gate scanning three-dimensional laser radar apparatus operating on such principles as fluorescence scattering, Raman scattering and differential absorption scattering, which uses a high-sensitivity, two-dimensional imaging CCD camera, an image intensifier or other two-dimensional photodetector suitable for use as a laser echo light signal receiver and detector that is designed to have a gating feature with short time slot, a fast gate scanning feature and a high frame (image capture) repetition rate so that a two- or three-dimensional spatial density distribution of fine particles, environmental pollutants, aerosols and other targets suspended in the atmosphere is acquired instantaneously whereas temporal changes in the direction, speed and flow of said distribution can be remotely monitored.

2. The laser radar apparatus according to claim 1, wherein the gating feature of the two-dimensional photodetector such as CCD camera is such that the intensity of a laser echo light signal within a gate time slot is detected after the delay of a given time setting, and the delay time of the gate with respect to the time at which laser was issued is controlled and scanned at high speed in either a continuous or discontinuous way to obtain two-dimensional distributed image data, which are subjected to fast framing (accumulated), whereby a three-dimensional distribution for parameters such as the distance from the site of installation of the apparatus to the target in the atmosphere, its concentration and speed can be measured instantaneously.

3. The laser radar apparatus according to claim 1, wherein the laser light used is pulsed light and can be applied over a wide range of the atmosphere in which the target is suspended or, if the range of laser application is narrow, is capable of scanning over a wide range of the atmosphere.

4. The laser radar apparatus according to claim 1, wherein the precision of the two- or three-dimensional spatial distribution to be obtained can be changed at will by adjusting the gate time slot of the fast gating feature of the two-dimensional photodetector such as CCD camera.

5. The laser radar apparatus according to claim 1, wherein the temporal changes in the information on the two- or three-dimensional distribution which is repeatedly obtained with the two-dimensional photodetector such as high-speed CCD camera are analyzed by the correlation method or the like to measure the speed and direction of the distribution of fine particles or aerosols suspended in the atmosphere.
